(19) United States
(12) Patent Application Publication
(10) Pub. No.: US 2011/0300988 A1
(43) Pub. Date: Dec. 8, 2011

(54) CONTINUOUSLY VARIABLE TRANSMISSION

(76) Inventor: Donghwan Byun, Seoul (KR)

(21) Appl. No.: 13/201,462

(22) PCT Filed: Feb. 16, 2010
(86) PCT No.: PCT/KR2010/000958

§ 371 Date: Aug. 14, 2011

(30) Foreign Application Priority Data
Feb. 16, 2009 (KR) 10-2009-0012240

(51) Int. Cl. F16H 15/16

(52) U.S. Cl. 476/39

(57) ABSTRACT

The present invention discloses a continuously variable transmission employing an inner-outer spherical traction drive system which uses as a power transmission medium a bevel gear having a traction power transmission surface with an obtuse-angle cone shape. The continuously variable transmission comprises: a gear mounted to rotate with respect to a frame in which the continuously variable transmission is installed, a traction member mounted to rotate coaxially with the gear, power transmission assemblies which include a power roller having a ribbed power transmission part on one side meshed with the gear and a power transmission surface on the other side traction-coupled with the traction member and which transmit torque as the power roller meshes with the gear and traction-couples with the traction member simultaneously, a support member which arranges the power transmission assemblies in a radial direction thereon and supports the power transmission assemblies to couple with the traction member, and a transmission unit which controls the axial position between the traction member and the power transmission assemblies. Therefore, the speed ratio between the gear and the traction member is continuously varied by the transmission unit.

### FIELD OF THE INVENTION

The present invention relates to a continuously variable transmission and discloses a continuously variable transmission employing an inner-outer spherical traction drive type which uses as a power transmission medium a bevel gear having a power transmission surface with an obtuse-angle cone shape.

### BACKGROUND OF THE INVENTION

The continuously variable transmission using the traction is not tied to the number of stages and allows for continuous speed change and thus facilitates adjustment of speed, and has relatively simple structure and thus is favorable to a low weight design. In addition, it has various theoretical potential. That is, it enables driving such that the power of the engine is maximally utilized to obtain excellent power performance and enhancement of fuel efficiency, and allows for easy driving and does not nearly cause shock according to the speed change. Furthermore, it allows for the speed change adapted to driving conditions of vehicle and therefore expecting of enhancement of the power performance, and can freely set transmission pattern so as to minimize fuel consumption.

Despite such theoretical potential, the continuously variable transmission has problems that it actually has low power density and power transmission efficiency, thereby generating a lot of heat, and has a short life time and narrow speed range and is restricted by increase of capacity of power transmission, and therefore so far it is difficult to be put to practical use.

Various types of such continuously variable transmissions using the traction is proposed, but in particular, there are a various pulley-belt type in which pulleys can be changed and a traction drive type in which rollers (traction wheels) are used and the like.

In the case of the continuously variable transmissions of various pulley-belt type currently commercialized, rotational radius of the belt can be varied by changing the pulley with a construction that one surface of the pulley can be separated and moved, and thus the speed can be continuously varied. Such various pulley-belt type is simple in structure and facilitates adjustment of position of the pulley.

Therefore, in contrast to the existing passive or automatic transmissions, the continuously variable transmissions of various pulley-belt type has features that it does not cause speed change shock, method of operating it is identical to that of the existing automatic transmission, and has fuel efficiency identical to or slightly better than passive transmission. However, such a transmissions of various pulley-belt type has a drawback that the belts should be specially fabricated with metal, and has a limit that range of speed change is narrow and range of power transmission is significantly restricted.

As the continuously variable transmissions of traction drive type, toroidal CVT and a continuously variable transmissions of an inner-outer spherical traction drive type may be mentioned. In the case of the toroidal CVT, the structure of variator for stepless speed change transmits force due to tractional force resulting from contact between two rotational discs defining grooves on toroidal surface and several rollers disposed between the discs, and transmission ratio is continuously varied by changing of effective radius of contact between the roller and the disc, whereby stepless speed change is achieved. The toroidal CVT has relatively wide range of speed change and relatively high performance of power transmission compared to the continuously variable transmission of various pulley-belt type described above, and thus is considered for use in middle sized vehicles. However, since the power is transmitted by contact between the outer spherical surface and outer spherical surface, larger shear pressure needs to be applied to contact portion in order to transmit larger power, so that the continuously variable transmission becomes larger in its size and heavier.

In the continuously variable transmission of inner-outer spherical traction drive type, abacus bead shaped or conical rollers are obliquely supported and contact with inner circumferential surface of traction ring and force is transmitted by tractional force, and transmission ratio is continuously varied by changing effective radius of contact between the rollers and the tractional ring by moving the tractional ring, whereby continuously variable transmission is achieved. Such a type of the continuously variable transmission has higher performance of power transmission than the toroidal type, thus has many cases of its being applied for industrial use, and can well perform power transmission without slip only with mechanism of traction between rotors by means of a simple mechanical pressing unit using the power transmitted to driving and driven shafts without a separate complex hydraulic device.

An another example of the continuously variable transmission of traction drive type is disclosed in WO 1999/20918. In this transmission, input disc for receiving the power and output disc for transmitting the power are disposed on both sides of a bearing, and speed change is achieved by inclining axis of the bearing, and transmission is relatively small, thus is used for bicycles. However, it is much heavier than the existing chain-type transmission or planetary gear hub-type transmission used for the bicycles.

When the continuously variable transmission of various pulley-belt type or traction drive type is to be applied to vehicles, additional devices are required in order to ensure functions of abrupt starting, abrupt accelerating etc. associated with performance of vehicle or achieve transmission into lower transmission ratio for re-start following panic stop, and thus the continuously variable transmission having theoretically simple construction is actually very complex in its structure.

### SUMMARY OF THE INVENTION

Therefore, the object of the present invention for solving the above-mentioned problems is to provide a continuously variable transmission that can well perform power transmission without slip phenomenon in tractional contact part by means of a simple mechanical pressing unit using the power transmitted to driving and driven shafts without a separate complex hydraulic device.

Another object of the present invention is to provide a continuously variable transmission that requires no additional devices for re-starting or abrupt starting and abrupt accelerating after panic stop and thus allows for substantially simple operation, simple structure, reduction of the number of parts, very small size and light weight and can be manufactured in a low cost.

Yet another object of the present invention is to provide a continuously variable transmission in which the range of input/output angular velocity ratio is not limited.

For achieving the above-mentioned object, the continuously variable transmission of the present invention comprises a gear mounted to rotate with respect to a frame in which the continuously variable transmission is installed; a traction member mounted to rotate coaxially with the gear; power transmission assemblies which include a power roller having a ribbed power transmission part on one side meshed with the gear and a power transmission surface on the other side traction-coupled with the traction member and which transmit torque as the power roller meshes with the gear and traction-couples with the traction member simultaneously; a support member which arranges a plurality of the power transmission assemblies in a radial direction thereon and supports the power transmission assemblies to couple with the traction member, and a transmission unit which controls the axial position between the traction member and the power transmission assemblies, wherein the angular velocity ratio between the gear and the traction member is continuously varied by the transmission unit. Furthermore, the transmission further comprises a central shaft for supporting the continuously variable transmission and hub shell for enclosing the continuously variable transmission.

It is preferable that the gear is a spur gear or bevel gear or another similar gear having a ribbed power transmission part engaging the ribbed power transmission part of the power roller to transmit the power between the gear and the power roller. It is preferable that the number of gear tooth is determined proportional to a multiple of power rollers and the width of the tooth is slightly larger than inverse proportion value.

It is preferable that the traction member is in the shape of a ring or disc having a convex power transmission surface for traction-coupling with the power roller. If the traction member is in the shape of a ring, the continuously variable transmission is embodied in a inner-outer spherical contact way in which the power rollers are disposed inside the ring, and if the traction member is in the shape of a disc, the continuously variable transmission of toroidal type is embodied in outer-outer spherical contact way in which the power rollers are disposed outside the disc.

It is preferable that the power roller has a conical power transmission surface, and a traction contact point between the power transmission surface and the traction member is positioned parallel to a direction of axis of the traction member. The conical power transmission surface may be formed on any one of front surface and rear surface facing to vertex of the bevel gear, and cone angle may be any one of acute angle, right angle and obtuse angle. In the case of inner-outer spherical contact way, it is efficient to form the power transmission surface on the rear surface, and in this connection, it is preferable that the power roller is a bevel gear or another similar gear having a conical power transmission surface of obtuse angle, and the more obtuse the cone angle is, the larger transmission ratio becomes.

The power transmission assemblies comprise the power roller and a roller housing for rotatably supporting the power roller, and the roller housing is coupled with the support member such that the housing can slide only in a radial direction, and it is preferable that the roller housing cannot rotate or axially move with respect to the support member.

Furthermore, it is preferable that the roller housing and the power roller each defines race groove of rolling bearing and cooperatively forms the rolling bearing. Such rolling bearing can bear relatively large bearing load compared to the size of the power transmission assemblies.

It is preferable that the support member is non-rotatably coupled with the frame to secure each power transmission assemblies in axial and rotational direction with respect to the support member and support the assembly such that it can radially translate. Therefore, the support member is fixedly coupled with one of the central shaft and hub shell which is secured to the frame so as not to rotate.

It is preferable that the continuously variable transmission further comprises a pressing member for radially pressing the power transmission assemblies such that each power transmission assembly can radially traction-couple with the traction member, and it is preferable that the pressing member further comprises means for controlling radial contact pressure such that the power transmission assemblies and the traction member can establish a traction coupling to transmit torque or uncouple from each other to interrupt the transmission of the torque. If radial contact pressure becomes high, the power can be transmitted without slip with large torque, and if adjustment is made such that the radial contact pressure becomes low or there is no contact, the slip occurs in the contact portion, thus the power cannot be transmitted.

It is preferable that the means for controlling radial contact pressure is a wedge that axially slides between the power transmission assembly and the support member, and it is preferable that each wedge is coupled with a pressing control shaft extending through from the outside of hub shell enclosing the continuously variable transmission to the inside of the hub shell. The pressing control shaft may be controlled in an axial direction by use of threads or similar mechanical link, and accordingly controls pressure of contact between the power rollers and traction ring or traction disc by radially controlling the power rollers.

Furthermore, each wedge may be supported on the support member and coupled with axially operated hydraulic cylinder, thereby axially translating. In the transmission in which the hydraulic device is already installed, when the hydraulic cylinder is to be applied, structure of the transmission may be more simple by properly disposing hydraulic pipes.

It is preferable that the transmission unit is constructed such that a part of the support member including the power transmission assemblies can axially slide, and is a transmission shaft that guides an axial position of the support member within hub shell enclosing the continuously variable transmission, or a transmission shaft that rotatably encloses the traction member within hub shell enclosing the continuously variable transmission and guides an axial position of the traction member. In the case that the support member can be axially moved, the traction ring or traction disc is installed so as to be axially secured. In this connection, it is not easy to properly control the wedges that move along the support member. In reverse, in the case that the traction ring or traction disc can be axially moved to perform the speed change, many instances are known of operating such that the traction ring or traction disc is rotated and axially moved.

The transmission shaft may be coupled with a mechanical link extending through from the outside of the hub shell enclosing the continuously variable transmission to the inside of the hub shell, and is controlled outside the hub shell, or may be coupled with the hydraulic cylinder and controlled in axial position.

The gear and the traction member of the transmission of the present invention are disposed dividing an input shaft and output shaft of the continuously variable transmission.

Therefore, the continuously variable transmission according to the present invention provides a continuously variable transmission that requires no additional devices for re-starting or abrupt starting and abrupt accelerating after panic stop and thus allows for substantially simple operation, simple structure, reduction of the number of parts, very small size and light weight and can be manufactured in a low cost.

Furthermore, the continuously variable transmission of the present invention provides a continuously variable transmission in which the range of input/output angular velocity ratio is not limited.

In addition, the continuously variable transmission of the present invention can provide an ideal input to output angular velocity ratio to save energy.

Furthermore, the continuously variable transmission of the present invention includes power transmitting apparatus with stepless speed change that can be used in all kinds of machines requiring the speed change. For example, the continuously variable transmission of the present invention can be used in powered vehicles such as automobiles, motor cycles or ships, non-powered vehicles such as bicycles, tricycles, scooters and exercise equipment, industrial power facilities such as drills, presses and conveyers, or power generation facilities such as wind power generator.

### BRIEF DESCRIPTION OF THE DRAWING

FIG. 1 is a sectional view of an example of the continuously variable transmission according to the present invention in which a central shaft is rotated.

FIG. 2 is a perspective view of FIG. 1.

FIG. 3 is a sectional view of FIG. 1.

### DETAILED DESCRIPTION OF EXEMPLARY EMBODIMENTS

Terms or words used in the specification and claims should not be limitedly interpreted as normal or lexical meanings, but should be interpreted as meanings and concepts coinciding to technical concepts of the present invention based on the principle that inventors may properly define the concepts of the terms in order to explain their inventions in a best way.

Therefore, examples described in the specification and constructions illustrated in the drawings are only most preferred example of the present invention, and do not represent all of the technical concepts of the present invention, and thus it should be understood that various equalities and modifications may be present which can replace them at the time of application of the present invention.

Herein, the term “axial direction” is used to refer to a direction or position along an axis parallel to a central shaft of a transmission or a central shaft of a support member. The term “radial direction” is used to refer to a direction or position extending perpendicular to the central shaft of the transmission.

Hereinafter, preferred examples of the present invention will be described in detail with reference to the attached drawings. Although the present example describes a continuously variable transmission (0) for use in bicycles, the continuously variable transmission (0) may be applied to any devices using a transmission.

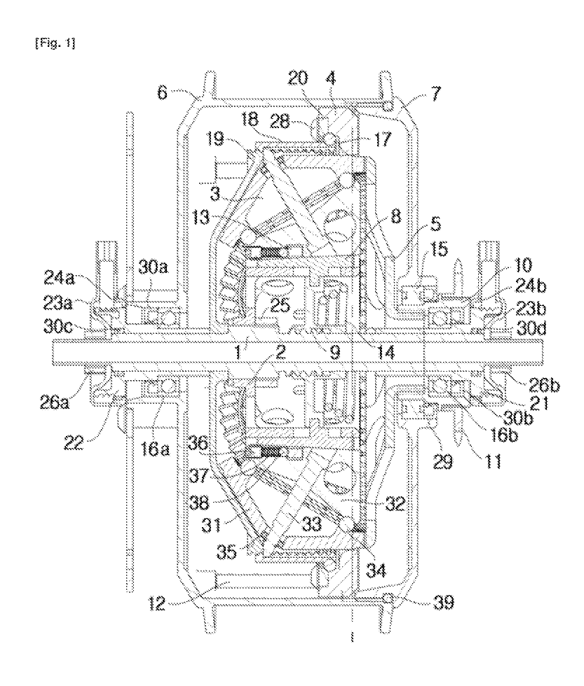

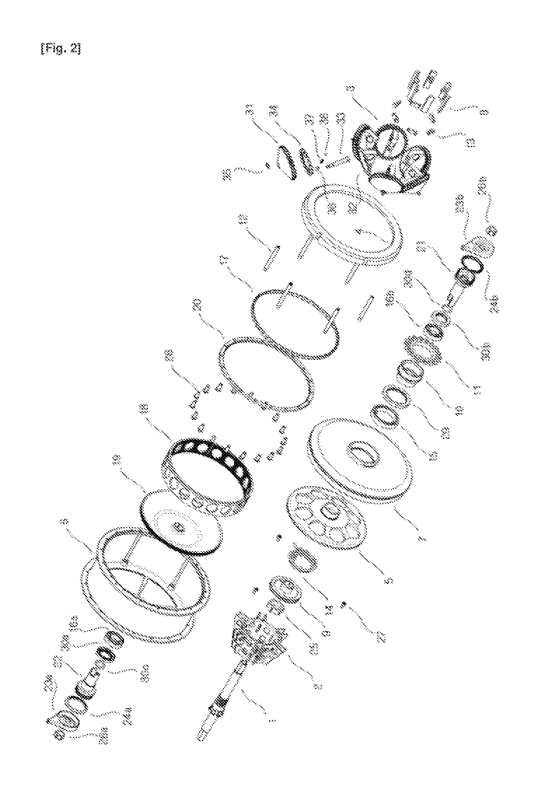

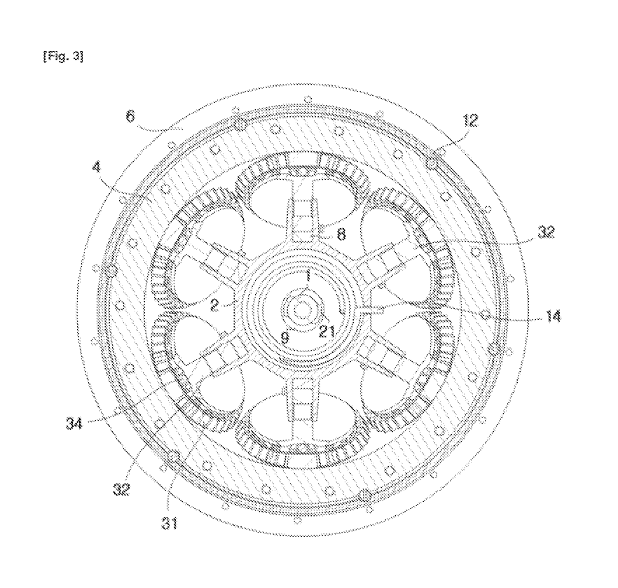

FIG. 1 shows an example of the continuously variable transmission according to the present invention, and is a sectional view of the continuously variable transmission constructed so as to be installed in a rear wheel of the bicycle, FIG. 2 is an exploded perspective view of FIG. 1, and FIG. 3 is a sectional view of FIG. 1 taken along line A-A.

The continuously variable transmission constructed so as to be installed in the rear wheel of the bicycle has a central shaft (1) that extends through a center of the transmission to be coupled with two rear dropouts (not illustrated in the drawings) of a body of the bicycle. Formed on both end portions of the central shaft (1) are threads and parts of the end portions have flat surfaces (1a, 1b) formed. The flat surfaces enable the central shaft (10) to be non-rotatably installed on the rear dropouts.

The central shaft (1) receives a transmission shaft (22) and a pressing shaft (21) and extends through hub shells (6, 7), supporting each of them such that they can be rotated, and supports a support member (2) such that it cannot be rotated, and supports the transmission shaft, the pressing shaft, the hub shells and the support member such that they can be all axially secured. Furthermore, formed on a middle portion of the central shaft is pressing thread (1c) for engaging the pressing shaft (21). In addition, there are formed spline (1d) for non-rotatably supporting the support member (2), and protrusion (1d) and thread (25) for preventing axial movement of the support member.

The hub shells (6, 7) are rotatably supported on the central shaft (1) and enclose 1 to 10 or more power transmission assemblies (3), the support member (2), an input gear (5) and a traction ring (4). Formed on an outer circumferential surfaces of the hub shells (6, 7) are a plurality of through holes for receiving spokes for connection to the wheel of the bicycle. Formed on inner side wall of the hub shell (6) are a plurality of axial grooves for receiving traction ring guide pins (12).

The traction ring (4) has convex protrusions formed on inner circumferential surface of the ring for coupling with power rollers (3), and formed on an outer circumferential surface of the ring are axial grooves for receiving the traction ring guide pins (12) for the ring to be axially slidingly coupled with the hub shell (6) and rotated along therewith.

Furthermore, a transmission guide ring (18) for axially guiding the traction ring (4) is rotatably coupled through a bearing (17). The transmission guide ring (18) is constructed such that it is coupled with power roller shafts (33) of the power transmission assemblies (3) to be non-rotatably supported and is coupled with a transmission screw (19) by threads to be axially moved according to rotation of the transmission screw (19).

The transmission shaft (22) is constructed such that it is coupled with the transmission screw (19) so as to be rotated along therewith, and axially secured by wire covers (23a, 24a) and spline protrusions (1d) of the central shaft, and can be rotated by pulling and unwinding a wire extending through the wire cover (23a) and winding around the transmission shaft (22).

The support member (2) for securing the power transmission assemblies (3) in axial and rotational direction and radially guiding the same has a protrusion with a spline bore at central portion thereof so as to engage the spline (1d) formed on the central shaft (1), and a body with polygonal wings formed on an outer circumferential surface thereof radially defining guide grooves for receiving wedges (8) for radially guiding the power transmission assemblies (3) and roller housings (32). Therefore, the number of the guide grooves in some of the examples may be 1 to 10 or more. Formed in each guide groove is a through groove extending toward a center of the shaft for axially guiding the wedges (8). Furthermore, side grooves for axially securing the roller housings (32) are formed on side walls of the guide grooves. The support member (2) is axially secured by means of the protrusions (1d) on the spline and the thread (25).

The power transmission assemblies (3) transfer a torque of the input gear (5) to the traction ring (4). In the present example six power transmission assemblies (3) are described in assembled state, but in various examples of the continuously variable transmission, about 2 to 16 or more power transmission assemblies (3) may be used depending on requirements of torque, weight and dimensions for each specific applications. The power transmission assemblies (3) comprises a power roller (31), a power roller shaft (33) for rotatably supporting the power roller, and a roller housing (32) coupled with the power roller shaft to radially guide the power roller shaft.

The power roller (31) is a bevel gear having a conical power transmitting surface. The input gear (5) engages concavo-convex part and the traction ring (4) contacts with the power transmitting surface, and applied to the power transmitting surface is very large contact force for transferring the torque. The input gear (5) transfers the input torque with input rotational speed to the power rollers (31). As the rollers (31) are rotated about its respective shaft (33), the power rollers (31) transfer the torque to the traction ring (4). Therefore, the ratio of input speed to output speed is a function of a radius of contact point of the input gear (5) and a radius of contact point of the traction ring (2) with respect to the power roller shaft (33). Herein, since the distance for the input gear is fixed, by adjusting axial position of the traction ring (4) along the central shaft (1) of the transmission, speed ratio can be continuously adjusted, and a positive rotation transmission is obtained where rotational direction of the input gear (5) is identical to that of the traction ring (4).

The cone angle defined in a section of the cone having the power transmitting surface may be any one of cute angle, right angle and obtuse angle, and is 120° in the present example. In this case, the power roller shaft (33) is arranged so as to form an angle of 60° with the central shaft. A protrusion extending from the power roller shaft (33) is inserted in axial guide groove of the transmission guide ring (18) to non-rotatably support the transmission guide ring (18).

The roller housing (32) is inserted in protrusion groove of the support member (2) to non-rotatably supported therein, and defines a securing pin groove in order that the roller housing is prevented from axially moving by the securing pin (13). Furthermore, a relatively large bearing (34) is formed in cooperation with the power roller (31) which bears high load exerted to the power roller (31). At the same time, the power roller (31) is rotatably supported through the power roller shaft (33) by a small bearing (35) such that the power roller (31) can be prevented from departing from the roller housing (32). The surface of the roller housing contacting with the pressing wedge (8) is made oblique such that the roller housing can be radially moved while engaging the pressing wedge (8).

The securing pin (13) is a rectangular pin extending through a groove of the roller housing (32) and a side wall groove of the support member (2) so as to axially secure the roller housing (32) and enable a radial movement thereof. There are arranged securing plungers (36, 37, 38) which prevent the pin from being withdrawn during operation and facilitate assembly and disassembly operations.

The pressing shaft (21) is constructed such that it is coupled with the pressing guide plate (9) so as to rotate along therewith, is axially secured by means of the wire covers (23b, 24b) and thread protrusion (1c) of the central shaft, and can be rotated by pulling and unwinding a wire extending through the wire cover (23b) and winding around the pressing shaft (21).

The pressing wedge (8) can axially move along the pressing guide plate (9) and acts as a wedge between the support member (2) and the roller housing (32). The surface of the pressing wedge contacting with the roller housing (32) is made oblique, and formed on the opposite side of the oblique surface of the pressing wedge (8) is a protrusion which extends through the support member to reach the pressing guide plate (9), thereby coupling the wedge with the pressing guide plate (9).

The pressing guide plate (9) is coupled with the central shaft by means of right handed thread (1c), and has engagement grooves for engaging each pressing wedge (8) such that the wedges can be simultaneously rotated in a rotational direction and axially securing the wedges, and can be rotated in an axial direction by torque applied from the pressing spring (14).

The pressing spring (14) provides the torque to the pressing guide plate (9) between the pressing guide plate (9) and the support member (2). This torque is adjusted so as to provide contact pressure suitable for transferring of power by contact between the power rollers (31) and the traction ring (4).

The hub shell cover (7) is coupled with the hub shell (6) by threads, and an oil seal (39) is arranged between them to achieve a sealed hub, communication between the inside and outside of which is interrupted. Uncoupling of the hub shell cover from the hub shell is prevented by cover securing bolts (27).

The input shaft (10), which is coupled with a sprocket (11) to transfer a driving torque to the transmission, is rotatably supported on the central shaft (1) to transfer the torque to the input gear (5), and rotatably supports the hub shell cover (7). An one-way clutch (not illustrated in the drawings) may be arranged between inner circumferential surface of the input shaft (10) and the input gear (5) to transfer only forward driving power for the bicycle.

The input gear (5) may be a bevel gear that is rotatably mounted on the central shaft (1) coaxially therewith. Axially formed on an axial end portion of the input gear (5) are teeth for meshing with the power rollers (31). Furthermore, with the input gear coupled with the input shaft by splines or threads, the torque from the sprocket (11) is transferred to the power rollers (31) via the input shaft.

Operational process of the continuously variable transmission of the present invention is described with reference to the attached drawings.

The pressing spring (14) is installed so as to apply a proper pressure to rotate the pressing guide plate (9) clockwise, thereby pressing the plate clockwise, so that the pressing guide plate (9) coupled with the central shaft (1) by right handed threads tends to advance while rotating. The pressing wedges (8) coupled with the pressing guide plate (9) advance and act as wedges to radially press the roller housings (32). Each power roller (31) abuts against the traction ring (4) and thus no longer cannot move radially and is kept in pressing contact with the traction ring (4).

At this time, if a crank of the bicycle (not illustrated in the drawings) is driven in a forward direction, the sprocket (11) engaging a chain is rotated clockwise. At the same time, the input shaft (10) is also rotated and the input gear (5) is also rotated clockwise, and accordingly the power rollers (31) engaging the input gear are also rotated together. The torque is transferred to the traction ring (4) already in pressing contact with the power rollers (31), whereby the traction ring is rotated and the hub shells (6, 7) coupled with the ring by the traction ring guide pins (12) are also rotated together, and thus the wheels of the bicycle are rotated to advance the bicycle.

If the transmission wire is pulled toward one side to adjust the speed during driving, the transmission shaft (22) is rotated by the pulled transmission wire, and according to the rotation of the shaft the transmission screw (19) is rotated together, whereby the transmission guide ring (9) is axially moved. At the same time, the traction ring (4) coupled with the ring through the bearing is also axially moved. At this time, a radius of contact point of the power roller (31) is varied, which results in the speed change. If the contact point is moved in the direction in which its radius is decreased, the speed is reduced and thus the hub shells (6, 7) are rotated more slowly than before. Furthermore, if the transmission wire is pulled toward the opposite side, the traction ring (4) is also moved in the opposite direction to be rotated more rapidly, causing the speed change.

In the case that more torque is needed during the driving (i.e., the cases of abrupt starting or abrupt accelerating, ascending the slope or driving on a muddy road), if pressing wire is pulled so as to rotate the pressing shaft (21) clockwise, the pressing guide plate (9) coupled with the pressing shaft (21) is rotated clockwise to advance the wedges (8), whereby the power rollers (31) contact with the traction ring (4) with more contact pressure, so desired torque can be further applied.

Furthermore, in the case that the speed change is needed during stop (the case that abrupt stop during driving at high speed is made followed by the change from stop state to a low speed), it is impossible to axially move the traction ring (4) because of high contact pressure already applied. At this time, if the pressing wire is pulled so as to rotate the pressing shaft (21) counterclockwise, the pressing guide plate (9) coupled with the pressing shaft (21) is rotated counterclockwise to move the wedges (8) backward, whereby the wedges (8) can alleviate or eliminate the pressing force with which the power rollers (31) press the traction ring (4). In such a state, if the transmission shaft (22) is actuated through the transmission wire, the change is made to a low speed position.

Following the change to a low speed position, if the transmission wire is released, the power rollers (31) and the traction ring (4) are returned to a pressing contact state by a restoring force of the pressing spring (14).

1. A continuously variable transmission comprising:
a gear mounted to rotate with respect to a frame in which the continuously variable transmission is installed;
a traction member mounted to rotate coaxially with the gear;
power transmission assemblies which include a power roller having
a ribbed power transmission part on one side meshed with the gear
and a power transmission surface on the other side traction-coupled with the traction member
and which transmit torque as the power roller meshes with the gear and traction-couples with the traction member simultaneously;
a support member which arranges a plurality of the power transmission assemblies in a radial direction thereon and supports the power transmission assemblies to couple with the traction member, and
a transmission unit which controls the axial position between the traction member and the power transmission assemblies,
wherein the speed ratio between the gear and the traction member is continuously varied by the transmission unit.

2. The continuously variable transmission according to claim 1, wherein the gear is a spur gear or bevel gear or another similar gear having a ribbed power transmission part engaging the ribbed power transmission part of the power roller to transmit the power between the gear and the power roller.

3. The continuously variable transmission according to claim 1, wherein the traction member is in the shape of a ring or disc having a convex power transmission surface for traction-coupling with the power roller.

4. The continuously variable transmission according to claim 1, wherein the power roller has a conical power transmission surface, and a traction contact point between the power transmission surface and the traction member is positioned parallel to a direction of axis of the traction member.

5. The continuously variable transmission according to claim 4, wherein the power roller is a bevel gear or another similar gear having a conical power transmission surface of obtuse angle.

6. The continuously variable transmission according to claim 1, wherein the power transmission assemblies comprise the power roller and a roller housing for rotatably supporting the power roller, and the roller housing is coupled with the support member such that the housing can slide only in a radial direction.

7. The continuously variable transmission according to claim 6, wherein the roller housing and the power roller each defines race groove of rolling bearing and cooperatively forms the rolling bearing.

8. The continuously variable transmission according to claim 1, wherein the support member is non-rotatably coupled with the frame to secure each power transmission assembly in axial and rotational direction with respect to the support member and support the assembly such that it can radially translate.

9. The continuously variable transmission according to claim 8, further comprising a pressing member for radially pressing the power transmission assemblies such that each power transmission assembly can radially traction-couple with the traction member.

10. The continuously variable transmission according to claim 9, wherein the pressing member further comprises means for controlling radial contact pressure such that the power transmission assemblies and the traction member can establish a traction coupling to transmit torque or uncouple from each other to interrupt the transmission of the torque.

11. The continuously variable transmission according to claim 10, wherein the means for controlling radial contact pressure is a wedge that axially slides between the power transmission assembly and the support member.

12. The continuously variable transmission according to claim 11, wherein each wedge is coupled with a pressing control shaft extending through from the outside of hub shell enclosing the continuously variable transmission to the inside of the hub shell.

13. The continuously variable transmission according to claim 11, wherein each wedge is supported on the support member and coupled with axially operated hydraulic cylinder, thereby axially translating.

14. The continuously variable transmission according to claim 1, wherein the transmission unit is constructed such that a part of the support member including the power transmission assemblies can axially slide, and is a transmission shaft that guides an axial position of the support member within hub shell enclosing the continuously variable transmission.

15. The continuously variable transmission according to claim 1, wherein the transmission unit is a transmission shaft that rotatably encloses the traction member within hub shell enclosing the continuously variable transmission and guides an axial position of the traction member.

16. The continuously variable transmission according to claim 14, wherein the transmission shaft is coupled with a mechanical link extending through from the outside of the hub shell enclosing the continuously variable transmission to the inside of the hub shell, and is controlled outside the hub shell.

17. The continuously variable transmission according to claim 14, wherein the transmission shaft is coupled with the hydraulic cylinder and controlled in axial position.

18. The continuously variable transmission according to claim 1, wherein the gear and the traction member are disposed dividing an input shaft and output shaft of the continuously variable transmission.

19. A continuously variable transmission, wherein as a power transmission medium a bevel gear or another similar gear is used which has a traction power transmission surface with an obtuse-angle cone shape.

20. The continuously variable transmission according to claim 15, wherein the transmission shaft is coupled with a mechanical link extending through from the outside of the hub shell enclosing the continuously variable transmission to the inside of the hub shell, and is controlled outside the hub shell.

21. The continuously variable transmission according to claim 15, wherein the transmission shaft is coupled with the hydraulic cylinder and controlled in axial position.
